(19) United States
(12) Patent Application Publication
(10) Pub. No.: US 2013/0292609 A1
(43) Pub. Date: Nov. 7, 2013

(54) PHOSPHOR MANUFACTURING METHOD

(71) Applicants: Kenji Toda, Niigata-shi (JP); Kazuyoshi Uematsu, Niigata-shi (JP); Mineo Sato, Niigata-shi (JP); Tadashi Ishigaki, Niigata-shi (JP); Yoshitaka Kawakami, Niihama-shi (JP); Tetsu Umeda, Niihama-shi (JP)

(72) Inventors: Kenji Toda, Niigata-shi (JP); Kazuyoshi Uematsu, Niigata-shi (JP); Mineo Sato, Niigata-shi (JP); Tadashi Ishigaki, Niigata-shi (JP); Yoshitaka Kawakami, Niihama-shi (JP); Tetsu Umeda, Niihama-shi (JP)

(73) Assignees: SUMITOMO CHEMICAL COMPANY, LIMITED, Chuo-ku, Tokyo (JP); NIIGATA UNIVERSITY, Niigata-shi, Niigata (JP)

(21) Appl. No.: 13/991,000

(22) PCT Filed: Dec. 2, 2011
(86) PCT No.: PCT/JP2011/077951

§ 371 Date: Jul. 25, 2013

(30) Foreign Application Priority Data
Dec. 2, 2010 (JP) 2010-269354

(51) Int. Cl. C09K 11/59

(52) U.S. Cl. CPC C09K 11/59
USPC 252/301.4 F; 423/325

(57) ABSTRACT

A method for producing a silicate-based oxynitride phosphor, comprising a step of firing a raw material mixture while contacting the raw material mixture with a Si-containing gas containing gas phase Si to generate a silicate-based oxynitride phosphor.

### TECHNICAL FIELD

The present invention relates to a method for producing a phosphor.

### BACKGROUND ART

Phosphor materials are widely used in application of lightings, displays, decoration, and the like. Recently, white LEDs have been used in backlights for liquid crystal televisions and lightings, and have been used in practice. The market of the white LED has been rapidly expanding. Following this, the market of the phosphor used in the white LED has been also expanding.

The white LED is composed of a combination of an LED chip that emits the light in the ultraviolet to blue region (wavelength is approximately 380 to 500 nm) and a phosphor that is excited by the light emitted from the LED chip to emit light. It is able to attain Colors of white at various color temperatures based on the combination of the LED chip and the phosphor.

The phosphor that is excited by the light in the ultraviolet to blue region to emit light, that is, a phosphor that may be used for the white LED has been already known. Particularly, a phosphor containing oxynitride is widely used because such a phosphor absorbs the light at a wavelength in the ultraviolet to blue region with high efficiency to be excited. Moreover, the phosphor containing oxynitride is widely used because its chemical stability is high.

For example, in Patent Literatures 1 to 6, an α-sialon phosphor is disclosed. In Patent Literature 7, a 1-sialon phosphor is disclosed.

### CITATION LIST

### Patent Literature

Patent Literature 1: Japanese Patent Application Laid-Open No. 2001-363554
Patent Literature 2: Japanese Patent Application Laid-Open No. 2003-336059
Patent Literature 3: Japanese Patent Application Laid-Open No. 2003-124527
Patent Literature 4: Japanese Patent Application Laid-Open No. 2003-206481
Patent Literature 5: Japanese Patent Application Laid-Open No. 2004-186278
Patent Literature 6: Japanese Patent Application Laid-Open No. 2004-244560
Patent Literature 7: International Publication No. WO 2006/121083

### SUMMARY OF INVENTION

### Technical Problem

The white LED is composed of a combination of an LED chip that emits the light in the ultraviolet to blue region (wavelength is approximately 380 to 500 nm) and a phosphor that is excited by the light emitted from the LED chip to emit light. For this reason, the phosphor is exposed to the light emitted from an exciting source whose energy is high (LED chip); as a result, deterioration of the phosphor is caused. Further, higher luminance of the LED has been developed. Because of increase in making current and the like, the phosphor used in the LED is exposed to severer environments. From this, development of a phosphor whose durability is high and that has high light emission intensity is demanded.

Then, in recent years, a silicate-based oxynitride phosphor whose crystal structure is stable and that is excited by the light in the ultraviolet to blue region efficiently to emit light has received attention.

An object of the present invention is to provide a method for producing a silicate-based oxynitride phosphor that exhibits high luminance.

### Solution to Problem

One aspect according to the present invention provides a method for producing a silicate-based oxynitride phosphor comprising a step of firing a raw material mixture while contacting the raw material mixture with a Si-containing gas containing a gas phase Si to generate a silicate-based oxynitride phosphor. In other words, another aspect according to the present invention is a method for producing a silicate-based oxynitride phosphor by firing a mixture containing elements constituting the phosphor, the method comprising a step of contacting the mixture with a Si-containing gas and firing the mixture.

In the producing method above, the silicate-based oxynitride phosphor is (i) (MₘLₙ)SiₚO_{q}Nᵣ (M is at least one element selected from Mg, Ca, Sr, and Ba, and L is at least one element selected from rare earth elements, Bi, and Mn), and may be (ii) an α-sialon phosphor or β-sialon phosphor, or (iii) M¹₂ₐ(M_{b}L_{c})M³_{d}O_{y}Nₓ. In (ii), m is 0.8 to 1.2, n is 0.001 to 0.2, p is 1.8 to 2.2, q is 1.5 to 4.5, and r is 0.5 to 2.2. In (iii), M¹ is at least one element selected from alkali metals, M² is at least one element selected from alkali earth metals, M³ is Si, or Si and Ge (at least one element selected from Si and Ge), L is at least one element selected from rare earth elements, Bi, and Mn, a is 0.9 to 1.5 (0.9 or more and 1.5 or less), b is 0.8 to 1.2 (0.8 or more and 1.2 or less), c is 0.005 to 0.2 (0.005 or more and 0.2 or less), d is 0.8 to 1.2 (0.8 or more and 1.2 or less), x is 0.001 to 1.0 (0.001 or more and 1.0 or less), and y is 3.0 to 4.0 (3.0 or more and 4.0 or less).

Further another aspect according to the present invention provides a light-emitting apparatus or white LED having a silicate-based oxynitride phosphor that can be manufactured by the producing method above.

### Advantageous Effects of Invention

According to the present invention, it is able to improve light emission intensity (luminance) of the obtained silicate-based oxynitride phosphor.

### BRIEF DESCRIPTION OF DRAWINGS

FIG. 1 is a schematic view showing one embodiment of a firing treatment apparatus that fires a raw material mixture.

FIG. 2 is a sectional view showing one embodiment of a light-emitting apparatus.

### DESCRIPTION OF EMBODIMENTS

Hereinafter, suitable embodiments of the phosphor obtained by the producing method according to the present invention and the producing method will be described in order. Herein, the term “metal element” is used as a meaning that includes metalloid elements such as Si and Ge.

The present embodiment relates to a silicate-based oxynitride phosphor (hereinafter, simply referred to as a phosphor in some cases). It is preferable that the target phosphor in the present embodiment be (i) a phosphor represented by (MₘLₙ)SiₚO_{q}Nᵣ, (ii) an α-sialon phosphor or β-sialon phosphor, or (iii) a phosphor represented by M¹₂ₐ(M²_{b}L_{c})M³_{d}O_{y}Nₓ.

In the phosphor represented by (MₘLₙ)SiₚO_{q}Nᵣ, M is at least one element selected from Mg, Ca, Sr, and Ba, L is at least one element selected from rare earth elements, Bi, and Mn, m is 0.8 to 1.2 (0.8 or more and 1.2 or less), n is 0.001 to 0.2 (0.001 or more and 0.2 or less), p is 1.8 to 2.2 (1.8 or more and 2.2 or less), q is 1.5 to 4.5 (1.5 or more and 4.5 or less), and r is 0.5 to 2.2 (0.5 or more and 2.2 or less).

In the α-sialon phosphor and the β-sialon phosphor, each of the sialon base crystals is doped with one or more elements selected from rare earth elements, Ca, Bi, and Mn, and the ratio of oxygen to nitrogen in the composition may be arbitrarily varied in the range in which each of the crystal structures can be kept.

In the phosphor represented by M¹₂ₐ(M²_{b}L_{c})M³_{d}O_{y}Nₓ, M¹ is at least one element selected from alkali metals, M² is at least one element selected from alkali earth metals (Ca, Sr, Ba), M³ is at least one element selected from Si and Ge, L is at least one element selected from the group consisting of rare earth elements, Bi, and Mn. a is 0.9 to 1.5, b is 0.8 to 1.2, c is 0.005 to 0.2, d is 0.8 to 1.2, x is 0.001 to 1.0, and y is 3.0 to 4.0.

The M¹ is preferably one or two or more (particularly one) elements selected from Li, Na, and K, and more preferably Li.

M² is one or two or more (particularly one) elements selected from Ca, Sr, and Ba, and more preferably Sr. In the case where M² contains Sr, it is preferable that M² further contain Ba and/or Ca, and it is more preferable that M² contain Ca.

L is an element to be doped in the base crystal as a light emission ion, and it is preferable that L contain at least Eu. For example, L can be Eu alone, or a combination of Eu and one or more element of L elements other than Eu (rare earth element, Bi, Mn). Particularly preferable, L is Eu. Further, it is preferable that Eu as L includes at least divalent Eu (Eu²⁺).

M³ is preferably Si. When M³ is Si, it is preferable that M¹ be Li.

The lower limit of a is preferably 0.95 or more. Moreover, the upper limit of a preferably 1.2 or less, further preferably 1.1 or less, and particularly preferably 1.05 or less.

The lower limit of b is 0.8 or more, and preferably 0.9 or more. Moreover, the upper limit of b preferably 1.1 or less, and more preferably 1.05 or less.

The lower limit of c is preferably 0.01 or more, and more preferably 0.015 or more. The upper limit of c is preferably 0.1 or less, and more preferably 0.05 or less. In other words, c is preferably 0.01 to 0.1, and more preferably 0.015 to 0.05.

The lower limits of a value of b+c and the lower limit of d may be the same or different, and are each preferably 0.9 or more, and more preferably 0.95 or more. The upper limits of a value of b+c and the lower limit of d may be the same or different, and are each preferably 1.1 or less, and more preferably 1.05 or less. In other words, the value of b+c and d may be the same or different, and preferably 0.9 to 1.1, more preferably 0.95 to 1.05, and still more preferably 1.

The lower limit of x is preferably 0.005 or more, and more preferably 0.01 or more. The upper limit of x is preferably 0.9 or less, and more preferably 0.85 or less. In other words, x is preferably 0.005 to 0.9, and more preferably 0.01 to 0.85.

The lower limit of y is preferably 3.5 or more, and more preferably 3.7 or more. Moreover, the upper limit of y is preferably 3.95 or less, and more preferably 3.9 or less. In other words, y is preferably 3.5 to 3.95, and more preferably 3.7 to 3.9. It is also preferable that y be 4-2x/3.

The ratio of a to b+c (a/(b+c)), the ratio of a to d (a/d), and the ratio of b+c to d ((b+c)/d) may be the same or different, and for example, are each 0.9 to 1.1, and preferably 0.95 to 1.05. Further, it is preferable that values of a, b+c, and d be within the range of 1±0.03, and it is particularly preferable that values of a, b+c, and d be 1. It is preferable that M¹ be L¹, M³ be Si, and M² be Sr alone, or Sr and Ca.

The silicate-based oxynitride phosphor obtained by the producing method according to the present embodiment is preferably hexagonal or trigonal.

The silicate-based oxynitride phosphor can be produced by contacting a mixture containing elements constituting the phosphor (raw material mixture) with a Si-containing gas (gas phase Si component) and firing the mixture. Namely, the silicate-based oxynitride phosphor can be produced by the method comprising a step of firing the raw material mixture while contacting the mixture with a Si-containing gas containing gas phase Si to generate a silicate-based oxynitride phosphor. In the producing method according to the present embodiment, the Si component in the phosphor is partially or totally fed as a gas phase, and the phosphor is synthesized. In this respect, the producing method according to the present embodiment is different from the conventional producing method. Accordingly, the mixture containing elements constituting the phosphor may contain no Si. In the producing method according to the present embodiment, the Si component is fed from the Si-containing gas even if the raw material mixture does not contain Si component.

The composition of the mixture containing elements constituting the phosphor is properly determined according to the composition of the obtained phosphor. For example, the compound containing elements that form the phosphor is selected from an oxide, a hydroxide, a nitride, a halide, an oxynitride, an acid derivative, and a salt (carbonate, nitric acid salt, and oxalic acid salt).

In the case where the phosphor represented by (iii) M¹₂ₐ(M²_{b}L_{c})M³_{d}O_{y}Nₓ above is obtained as the phosphor, the mixture containing elements constituting the phosphor may be a mixture of a substance containing an element M¹ (first raw material), a substance containing an element M² (second raw material), and a substance containing an element L (third raw material). When necessary, a substance containing an element M³ (fourth raw material) may be mixed with the mixture. The elements M¹, M², L, and M³ each are a metal element (including a metalloid element). For this reason, herein, the first to fourth raw materials are referred to as a metal element-containing substance in some cases, and the mixture thereof is referred to as a metal compound mixture in some cases. The metal element-containing substance may be an oxide of a metal M¹, M², L, or M³, or may be a substance that decomposes or oxidizes at a high temperature (particularly firing temperature) to form an oxide thereof. Examples of the substance that forms an oxide include hydroxides, nitrides, halides, oxynitrides, acid derivatives, and salts (such as carbonates, nitric acid salts, and oxalic acid salts).

The first raw material is preferably selected from hydroxides, oxides, carbonates, nitrides, and oxynitride of a metal M¹ (particularly lithium). Examples of a particularly preferable first raw material include lithium hydroxide (LiOH), lithium oxide (Li₂O), lithium carbonate (Li₂CO₃), or lithium nitride (Li₃N). Any of these first raw materials may be used alone or in combinations of two or more.

Preferable examples of the second raw material include hydroxides, oxides, carbonates, nitrides, or oxynitride of a metal M² (particularly strontium, barium, and calcium, for example). More specifically, the second raw material is selected from, for example, strontium hydroxide (Sr(OH)₂), strontium oxide (SrO), strontium carbonate (SrCO₃), strontium nitride (Sr₃N₂), and calcium carbonate (CaCO₃). Any of these second raw materials may be used alone or in combinations of two or more.

It is preferable that the third raw material be a hydroxide, an oxide, a carbonate, a chloride, a nitride, or an oxynitride of a metal L (particularly europium). The third raw material is selected from, for example, europium hydroxide (Eu(OH)₂, Eu(OH)₃), europium oxide (EuO, Eu₂O₃), europium carbonate (EuCO₃, Eu₂(CO)₃), europium chloride (EuC₂, EuC₃), europium nitrate (Eu(NO₃)₂, Eu(NO₃)₃), and europium nitride (Eu₃N₂, EuN). Any of these third raw materials may be used alone or in combinations of two or more.

The fourth raw material is preferably selected from, an oxide, acid derivative, salt, nitride, oxynitride and the like of a metal M³ (particularly silicon). Examples of a preferable fourth raw material include silicon dioxide, silicic acid, silicic acid salt, or silicon nitride.

The first raw material to the third raw material are mixed in the range in which the atomic ratio of the elements M¹, M², L, and M³ fed from the respective raw materials and the Si-containing gas satisfies the relationship among a, b, c, and d in the formula M¹₂ₐ(M²_{b}L_{c})M³_{d}O_{y}Nₓ. In the case where the fourth raw material is used, it is preferable that the fourth raw material be mixed in the range in which the atomic ratio of the elements M¹, M², L, and M³ fed from the first to fourth raw materials and the Si-containing gas satisfies the relationship among a, b, c, and d in the formula M¹₂ₐ(M²_{b}L_{c})M³_{d}O_{y}Nₓ.

The first raw material to the third raw material (preferably the first raw material to the fourth raw material) may be mixed by a wet method, or mixed by a dry method. In this mixing, a general-purpose apparatus such as a ball mill, a V type mixer, and a stirrer may be used, for example.

In the case where (ii) the α-sialon phosphor or β-sialon phosphor is obtained as the phosphor, for example, α-sialon or β-sialon may be mixed with the substance containing the metal L to prepare a raw material mixture. Moreover, in the case where the phosphor represented by (i) (MₘLₙ)SiₚO_{q}Nᵣ (M is at least one element selected from Mg, Ca, Sr, and Ba, and L is at least one element selected from rare earth elements, Bi, and Mn) is obtained as the phosphor, the substance containing the metal M, the substance containing the metal L, and when necessary the substance containing Si may be mixed to prepare a raw material mixture. As the substance containing the metal L, the same substance as that used to obtain (iii) the phosphor may be used. As the substance containing Si, the same substance as the fourth raw material used to obtain (iii) the phosphor above (wherein M³ is silicon) may be used. As the substance containing metal M, the same substance as the second raw material used to obtain (iii) the phosphor (wherein the metal M² is Ca, Sr, or Ba) may be used.

Even if one of the silicate-based oxynitride fluorescent bodies (i) to (iii) is obtained, it is preferable that nitride or oxynitride be used for at least one among the metal element-containing substances. By doing this, the nitrogen component in the silicate-based oxynitride phosphor can be fed.

In the producing method according to the present embodiment, as described above, the silicate-based oxynitride phosphor is produced by firing the raw material mixture (metal compound mixture) while contacting the raw material mixture with the Si-containing gas (gas containing the gas phase Si component). If a fired product (silicate-based oxynitride phosphor) is produced while the Si-containing gas is utilized, the Si component fed as the gas phase acts as a reducing agent that efficiently reduces Eu (light emission ion) that is doped in the base crystal of the phosphor. Further, the Si component fed as the gas phase promotes growth of particles in the generated phosphor, and therefore a silicate-based oxynitride phosphor with high luminance (high light emission intensity) can be produced.

In the step of firing the raw material mixture (metal compound mixture) while contacting the raw material mixture with the Si-containing gas, for example, the raw material mixture may be fired in the Si-containing gas atmosphere. The Si-containing gas may be diluted with a gas other than Si, or pressurized, as described later.

The Si-containing gas can be generated, for example, by heating a Si-containing compound (preferably SiO) such as a silicon alkoxide compound, mullite, and silicon oxide (such as SiOx) to a high temperature. The temperature for heating the Si-containing compound (generation temperature) is, for example, 1300° C. or more, preferably 1350° C. or more, more preferably 1380° C. or more, and particularly preferably 1400° C. or more. The upper limit of the heating temperature is not particularly limited, and is, for example, 1600° C. or less, preferably 1500° C. or less, and more preferably 1450° C. or less. Moreover, it is preferable that the proportion of the Si-containing compound to be used be 30 to 70 parts by mass based on 100 parts by mass of the metal compound mixture in total, and it is more preferable that the proportion of the Si-containing compound to be used be 40 to 60 parts by mass based on 100 parts by mass of the metal compound mixture in total.

The Si-containing gas may be composed of only the component generated by heating the Si-containing compound (gas phase Si), and is usually diluted with other gas (such as an inert gas and a reducing gas). Examples of the inert gas can include nitrogen and argon. Examples of the reducing gas include a mixed gas of 0.1 to 10% by volume of hydrogen and an inert gas (such as nitrogen and argon), or a mixed gas of 10 to 100% by volume (preferably 50 to 100% by volume) of NH₃ and an inert gas (such as nitrogen and argon). In the case where the raw material mixture is fired in the Si-containing gas atmosphere, it is preferable that the Si-containing gas be diluted with an inert gas or a reducing gas, and it is more preferable that the Si-containing gas be diluted with a mixed gas of 0.1 to 10% by volume of hydrogen and an inert gas (such as nitrogen and argon). The Si-containing gas that may be diluted may be pressurized when necessary.

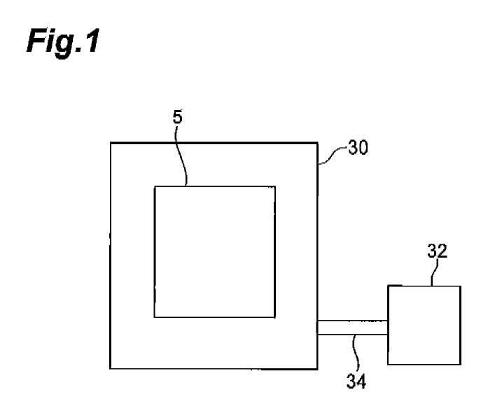

It is preferable that generation of the gas phase Si contained in the Si-containing gas be performed in a place different from the place for firing the phosphor. Namely, it is preferable that the Si-containing compound be heated in a place different from a firing chamber that fires the raw material mixture (such as a heating furnace), thereby to generate the gas phase Si. Generation of the gas phase Si in the place different from that for firing is excellent in a respect in which generation of the gas phase Si and firing of the raw material mixture can be performed at different temperatures. For example, the gas phase Si can be generated at 1500° C., and firing of the raw material mixture can be performed at 900° C. In this case, for example, as shown in FIG. 1, a firing chamber 30 that fires a raw material mixture 5 and a heating furnace 32 in which the Si-containing compound is heated are connected via a piping 34. In this case, other gas may be flowed from the Si-containing gas generation place (heating furnace 32) to the firing place (firing chamber 30), and the Si-containing gas may be carried on the other gas and fed to the firing place.

As long as the mixture containing elements constituting the phosphor (raw material mixture) and the Si-containing gas are contacted and the raw material mixture is fired, the firing condition in the producing method according to the present embodiment may be properly changed in the condition that enables producing of each of the fluorescent bodies. For example, the same condition as the condition used to fire the conventional phosphor represented by M¹₂ₐ(M²_{b}L_{c})M³_{d}O₄ may be used. For example, the atmosphere in the firing chamber, namely, the firing atmosphere may be any of an inert gas atmosphere and reducing gas atmosphere as long as contact of the raw material mixture (metal compound mixture) with the Si-containing gas is allowed. In the case where the raw material mixture is fired in a strong reducing atmosphere, a proper amount of carbon may be added to the raw material mixture (metal compound mixture).

The firing may be repeatedly performed several times. At this time, the firing atmosphere may be changed in the first firing and in the second firing, and the firing atmosphere may also be changed in the third or later firing. For example, in the case where firing is performed under an inert gas atmosphere, it is preferable that firing be subsequently performed further in a reducing gas atmosphere.

In the case where firing is performed several times, the raw material mixture may be fired in an atmosphere in which no Si-containing gas exists in the other firing, as long as the raw material mixture (including a product under fired) is contacted with the Si-containing gas in one or more of the firings.

The firing temperature is usually 700 to 1000° C., preferably 750 to 950° C., and more preferably 800 to 900° C. The firing time is usually 1 to 100 hours, preferably 10 to 90 hours, and more preferably 20 to 80 hours.

The method according to the present embodiment may further comprise the step of keeping the raw material mixture, when necessary, at a temperature lower than that in the firing (for example, 500 to 800° C.) for a predetermined period of time (for example, 1 to 100 hours, and preferably 10 to 90 hours), and calcining the raw material mixture prior to the firing.

In the method according to the present embodiment, when necessary, calcining or firing may be performed in the presence of a reaction accelerator. By use of the reaction accelerator, the light emission intensity of the obtained phosphor can be improved. The reaction accelerator is selected from, for example, alkali metal halides, alkali metal carbonates, alkali metal hydrogencarbonates, halogenated ammonium, oxide of boron (B₂O₃), and oxo acid of boron (H₃BO₃). The alkali metal halide is preferably fluorides of alkali metals or chlorides of alkali metals, and LiF, NaF, KF, LiCl, NaCl, or KCl, for example. The alkali metal carbonates are Li₂CO₃, Na₂CO₃, or K₂CO₃, for example. The alkali metal hydrogencarbonate is NaHCO₃, for example. The ammonium halide is NH₄Cl or NH₄I, for example.

The calcined product or the fired products may be subjected to one or more treatments such as crushing mixing, washing, and classification, when necessary. A ball mill, a V type mixer, a stirrer, and a jet mill may be used in crushing and mixing, for example.

The silicate-based oxynitride phosphor obtained by the producing method according to the present embodiment may contain a halogen element, namely, one or more elements of F, Cl, Br, and I, which are derived from the metal element-containing substance. The total content of the halogen element(s) may be the same as or less than the total amount of the halogen element(s) contained in the raw material, and preferably 50% or less, and more preferably 25% or less based on the total amount of the halogen element(s) contained in the raw material.

According to the producing method according to the present embodiment, it is able to obtain a silicate-based oxynitride phosphor that can be synthesized at a low temperature with high luminance. According to the producing method, firing is performed while the Si-containing gas is utilized; for this reason, the light emission intensity (luminance) of the obtained silicate-based oxynitride phosphor can be further enhanced. The silicate-based oxynitride phosphor has high light emission intensity, and therefore can be suitably used in a light-emitting apparatus (such as the white LED). The white LED is composed of a light-emitting device (LED chip) that emits the ultraviolet to blue light (wavelength is approximately 200 to 550 nm, and preferably approximately 380 to 500 nm) and a fluorescent layer including a phosphor. The white LED can be produced, for example, by the methods disclosed in Japanese Patent Application Laid-Open Nos. 11-31845 and 2002-226846. Namely, for example, the white LED can be produced by the method in which the light-emitting device is sealed with a light-transmittable resin such as an epoxy resin and a silicone resin, and the surface thereof is covered with the phosphor. If the amount of the phosphor is properly set, the white LED is formed to emit the light of a desired white color.

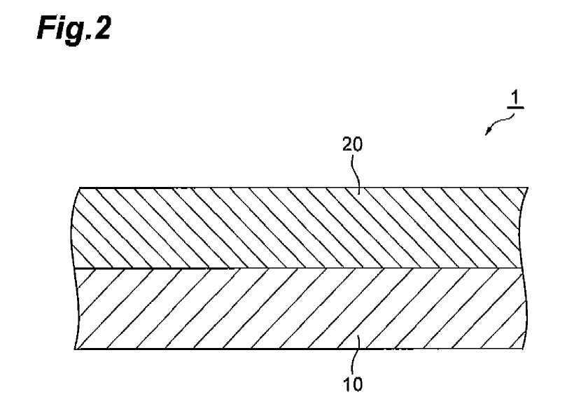

FIG. 2 is a sectional view showing one embodiment of the light-emitting apparatus. A light-emitting apparatus 1 shown in FIG. 2 includes a light-emitting device 10, and a fluorescent layer 20 provided on the light-emitting device 10. The phosphor that forms the fluorescent layer 20 receives the light from the light-emitting device 10 to be excited and emit fluorescence. By properly setting the kind, amount, and the like of the phosphor that forms the fluorescent layer 20, white light emission can be obtained. Namely, a white LED can be formed. The light-emitting apparatus or white LED according to the present embodiment is not limited to the form shown in FIG. 2, and can be properly modified without departing from the gist of the present invention.

The phosphor may contain the phosphor obtained by the producing method according to the present embodiment alone, or may further contain other phosphor. The other phosphor is selected from, for example, BaMgAl₁₀O₁₇:Eu, (Ba,Sr,Ca)(Al,Ga)₂S₄:Eu, BaMgAl₁₀O₁₇:(Eu,Mn), BaAl₁₂O₁₇:(Eu,Mn), (Ba,Sr,Ca)S:(Eu,Mn), YBO₃:(Ce,Tb), Y₂O₃:Eu, Y₂O₂S:Eu, YVO₄:Eu, (Ca,Sr)S:Bu, SrY₂O₄:Eu, Ca—Al—Si—O—N:Eu, (Ba,Sr,Ca)Si₂O₂N₂:Eu, α-sialon, CaSc₂O₄:Ce, and Li—(Ca,Mg)-Ln-Al—O—N:Eu (wherein Ln represents a rare earth metal element other than Eu).

Examples of the light-emitting device that emits light with a wavelength of 200 nm to 550 nm include ultraviolet LED chips and blue LED chips. In these LED chips, a semiconductor having a layer of GaN, InᵢGa₁₋ᵢN (0<i<1), InᵢAljGa₁₋ᵢ₋ⱼN (0<i<1, 0<j<1, i+j<1) is used as the light emitting layer. By changing the composition of the light emitting layer, the light emission wavelength can be changed.

The silicate-based oxynitride phosphor obtained by the producing method according to the present embodiment can also be used in the light-emitting apparatus other than the white LED, for example, light-emitting apparatuses whose phosphor exciting source is vacuum ultraviolet light (such as PDP); light-emitting apparatuses whose phosphor exciting source is ultraviolet light (such as backlights for liquid crystal displays and three band fluorescent lamps); and light-emitting apparatuses whose phosphor exciting source is an electron beam (such as CRT and FED).

### EXAMPLES

Hereinafter, the present invention will be more specifically described using Examples. The present invention will not be limited by Examples below, and the present invention, of course, can be implemented by adding proper modifications within the range in which the modifications can be complied with the gist described above and that described later, and those modifications are included in the technical scope of the present invention.

The light emission intensity of the phosphor obtained in Examples below was determined using a fluorescence spectrometer (made by JASCO Corporation, FP-6500). Moreover, the contents of oxygen and nitrogen in the phosphor were measured using EMGA-920 made by HORIBA, Ltd. For the content of oxygen, a non-dispersive infrared absorption method was used, and for the content of nitrogen, a thermal conductivity method was used.

### Comparative Example 1

Carcium carbonate (made by KANTO CHEMICAL CO., INC., purity of 99.99%), europium oxide (made by Shin-Etsu Chemical Co., Ltd., purity of 99.99%), aluminum nitride (made by Tokuyama Corporation), and silicon nitride (made by Ube Industries, Ltd.) were weighed such that the atomic ratio of Ca:Eu:Si:Al was 1.4:0.075:8,975:3.025, and these were mixed with a dry ball mill for 6 hours to obtain a metal compound mixture. The obtained metal compound mixture was housed in a firing furnace.

N₂ gas containing 5% by volume of H₂ was flowed in the firing furnace, and the metal compound mixture was heated (fired) at 1500° C. for 6 hours. This was gradually cooled to room temperature to obtain a phosphor containing a compound represented by the formula Ca_{1.4}Eu_{0.075}Si_{8.975}Al_{3.025}O_{0.075}N_{14.6}. The light emission intensity (peak intensity) when the obtained phosphor was excited by the light with a wavelength (peak wavelength) of 590 nm was defined as 100.

### Example 1

Carcium carbonate (made by KANTO CHEMICAL CO., INC., purity of 99.99%), europium oxide (made by Shin-Etsu Chemical Co., Ltd., purity of 99.99%), aluminum nitride (made by Tokuyama Corporation), and silicon nitride (made by Ube Industries, Ltd.) were weighed such that the atomic ratio of Ca:Eu:Si:Al was 1.4:0.075:8.9:3.025, and these were mixed with a dry ball mill for 6 hours to obtain a metal compound mixture. The obtained metal compound mixture was housed in a firing furnace.

50 parts by mass of SiO (made by Wako Pure Chemical Industries, Ltd.) was weighed based on 100 parts by mass of the metal compound mixture, and placed in an air-tight heating furnace connected to the firing furnace via a piping. SiO was heated to 1500° C. to generate gas phase Si, and N₂ gas containing 5% by volume of H₂ was flowed to feed the gas containing the gas phase Si (Si-containing gas) to the firing furnace and contact the Si-containing gas with the metal compound mixture.

While the Si-containing gas was continuously fed, the metal compound mixture was heated (fired) at 1500° C. for 6 hours. This was gradually cooled to room temperature to obtain a phosphor containing a compound represented by the formula Ca_{1.4}Eu_{0.075}Si_{8.975}Al_{3.025}O_{0.075}N_{14.6}. The light emission intensity when the obtained phosphor was excited on the same condition as that in Comparative Example 1 was 253 wherein the light emission intensity in Comparative Example 1 was 100.

### Comparative Example 2

Lithium carbonate (made by KANTO CHEMICAL CO., INC., purity of 99%), strontium carbonate (made by Sakai Chemical Industry Co., Ltd., purity of 99% or more), europium oxide (made by Shin-Etsu Chemical Co., Ltd., purity of 99.99%), silicon dioxide (made by Nippon Aerosil Co., Ltd.: purity of 99.99%), and silicon nitride (made by Ube Industries, Ltd.) were weighed such that the atomic ratio of Li:Sr:Eu:Si(SiO₂):Si(Si₃N₄) was 1.96:0.98:0.02:0.98:0.02, and these were mixed with a dry ball mill for 6 hours to obtain a metal compound mixture. The obtained metal compound mixture was housed in a firing furnace.

N₂ gas containing 5% by volume of H₂ was flowed in the firing furnace, and the metal compound mixture was heated (fired) at 900° C. for 24 hours. This was gradually cooled to room temperature to obtain a phosphor containing a compound represented by the formula Li_{1.96}(Sr_{0.98}Eu_{0.02})SiO_{3.88}N_{0.08}. The light emission intensity (peak intensity) when the obtained phosphor was excited by the light with a wavelength (peak wavelength) of 570 nm was defined as 100.

### Example 2

Lithium carbonate (made by KANTO CHEMICAL CO., INC., purity of 99%), strontium carbonate (made by Sakai Chemical Industry Co., Ltd., purity of 99% or more), europium oxide (made by Shin-Etsu Chemical Co., Ltd., purity of 99.99%), silicon dioxide (made by Nippon Aerosil Co., Ltd.: purity of 99.99%), and silicon nitride (made by Ube Industries, Ltd.) were weighed such that the atomic ratio of Li:Sr:Eu:Si(SiO₂):Si(SiN₄) was 1.96:0.98:0.02:0.95:0.02, and these were mixed with a dry ball mill for 6 hours to obtain a metal compound mixture. The obtained metal compound mixture was housed in a firing furnace.

50 parts by mass of SiO (made by Wako Pure Chemical Industries, Ltd.) was weighed based on 100 parts by mass of the metal compound mixture, and placed in an air-tight heating furnace connected to the firing furnace via a piping. SiO was heated to 1500° C. to generate gas phase Si, and N₂ gas containing 5% by volume of H₂ was flowed to feed the gas containing the gas phase Si (Si-containing gas) to the firing furnace, and contact the Si-containing gas with the metal compound mixture.

While the Si-containing gas was continuously fed, the metal compound mixture was heated (fired) at 900° C. for 24 hours. This was gradually cooled to room temperature to obtain a phosphor containing a compound represented by the formula Li_{1.96}(Sr_{0.98}Eu_{0.02})SiO_{3.88}N_{0.08}. The light emission intensity when the obtained phosphor was excited on the same condition as that in Comparative Example 2 was 121 wherein the light emission intensity in Comparative Example 2 was 100.

### REFERENCE SIGNS LIST

1 . . . light-emitting apparatus, 5 . . . raw material mixture, 10 . . . light-emitting device, 20 . . . fluorescent layer, 30 . . . firing chamber, 32 . . . heating furnace, 34 . . . piping.

1. A method for producing a silicate-based oxynitride phosphor, comprising
a step of firing a raw material mixture while contacting the raw material mixture with a Si-containing gas containing gas phase Si to generate a silicate-based oxynitride phosphor.

2. The method according to claim 1, wherein the silicate-based oxynitride phosphor is represented by (MₘLₙ)SiₚO_{q}Nᵣ,
M is at least one element selected from Mg, Ca, Sr, and Ba,
L is at least one element selected from rare earth elements, Bi, and Mn,
m is 0.8 to 1.2,
n is 0.001 to 0.2,
p is 1.8 to 2.2,
q is 1.5 to 4.5, and
r is 0.5 to 2.2.

3. The method according to claim 1, wherein the silicate-based oxynitride phosphor is an α-sialon phosphor or a β-sialon phosphor.

4. The method according to claim 1, wherein the silicate-based oxynitride phosphor is represented by M¹₂ₐ(M²_{b}L_{c})M³_{d}O_{y}Nₓ,
M¹ is at least one element selected from alkali metals,
M² is at least one element selected from alkali earth metals,
M³ is Si, or Si and Ge,
L is at least one element selected from rare earth elements, Bi, and Mn,
a is 0.9 to 1.5,
b is 0.8 to 1.2,
c is 0.005 to 0.2,
d is 0.8 to 1.2,
x is 0.001 to 1.0, and
y is 3.0 to 4.0.

5. A light-emitting apparatus having a silicate-based oxynitride phosphor that can be produced by the method according to claim 1.

6. A white LED having a silicate-based oxynitride phosphor that can be produced by the method according to claim 1.
